(19) United States
(12) Patent Application Publication
(10) Pub. No.: US 2024/0273446 A1
(43) Pub. Date: Aug. 15, 2024

(54) METHOD FOR ENSURING HIGHLY RELIABLE EXECUTION OF PROCESSES AND CONTINUOUS OPTIMIZATION OF HUMAN WORKFLOWS THROUGH REAL-TIME MEASUREMENT AND SCORING OF HUMAN PERFORMANCE

(71) Applicants: Dean Hamilton, Escondido, CA (US); Bill Chin, Sunnyvale, CA (US); Noah Singer, Seattle, WA (US)

(72) Inventors: Dean Hamilton, Escondido, CA (US); Bill Chin, Sunnyvale, CA (US); Noah Singer, Seattle, WA (US)

(21) Appl. No.: 18/168,945

(22) Filed: Feb. 14, 2023

(51) Int. Cl. G06Q 10/0639; G06Q 10/0633

(52) U.S. Cl. CPC G06Q 10/06398; G06Q 10/0633

(57) ABSTRACT

A method to score human performance, enabling high-reliability execution and continuous real-time optimization of human workflows is disclosed. The process which is operated is instrumented to ensure that relevant human performance indicators can be measured during operation. These indicators are then used to compute human performance scores for individuals, teams and organizations. The human performance scores are then used to summarize and provide insights into the human performance aspects of operating processes and to inform the higher-level human workflow management systems.

### FIELD OF THE INVENTION

The present invention relates to a novel method for measuring and using human performance to optimize and ensure the reliable completion of processes and integrations of human workflows.

### BACKGROUND OF THE INVENTION

Complex processes operated by humans can be difficult to understand and manage. Ensuring high performance, as measured by the reliability of the process outcomes, has many factors that affect success. Automation has emerged as a critical enabler for managing complex processes operated by humans, but until this invention, we have limited visibility and understanding of the human/machine interface and the human factors that affect high performance while operating a complex process.

For example, a significant number of cybersecurity breaches can be directly linked to human error during the execution of high-risk processes. Cyber insurance providers do not have any ability to quantify the amount of risk associated with human performance. This invention allows enterprises and interested partners such as cyber insurers to view how well an organization is performing at human performance and to model how human performance affects overall cybersecurity risk.

In this invention, we fill this gap by providing methods to accurately measure human performance by ensuring that the process that is operationalized has appropriate structure to enable the calculation of human performance scores. We provide a method for computing one or more human performance scores that directly measure the effectiveness of a single operator, a team of operators and/or teams of operators on the desired outcomes of a process, associated runbooks and governing policies. We also show how these human performance scores can be calculated, analyzed and visualized in order to track, both in real-time and historically how the operator, team of operators and/or teams of operators are performing and to inform higher-level workflow management system.

### SUMMARY OF THE INVENTION

The present invention provides a means to measure the human performance of an individual, team of individuals or teams of individuals performing a process. The invention ensures that the process that is being performed includes critical measures of human performance by articulating how and where the information is obtained within the process that is to be performed. The invention analyzes the operational state and state transitions of the process in order to perform measurements of human performance. The invention provides a visualization of the current operational state of the process as well as access to summary statistics that can be used to track human performance over time. Additionally, the invention includes the option to offer recommendations to improve the process itself, associated runbooks, governing policies, and/or to improve the human performance of any humans interacting with the process.

### BRIEF DESCRIPTION OF THE DRAWINGS

FIG. 1 shows the relationship between policies and the behavior of a system.

FIG. 2 shows how processes, composed of procedures implement a policy and runbooks.

FIG. 3 shows how procedures are composed of states and transitions between states.

FIG. 4 shows how an alert and an escalation are related to states within procedures.

FIG. 5 shows how an alert can be raised by an unexpected condition during state transitions.

FIG. 6 shows how a Watch Team Confirmation affects the state transitions in a procedure.

FIG. 7 shows how an unacknowledged state is related to states within a procedure.

FIG. 8 shows the detailed escalation procedures.

FIG. 9 shows a human workflow management system.

FIG. 10 shows how human performance scores inform a human workflow management system.

### DETAILED DESCRIPTION OF THE INVENTION

Here is a list of definitions for terms that we'll use in the following description:
System: Group of entities serving a common purpose
Policy: Set of rules that specify a behavior in a system
Runbook: Set of processes that implement a policy within a system
Process: Set of procedures contained in a runbook.
Procedure: A set of steps performed as part of a process
State: A specific set of conditions derived from a sequence of events
Unacknowledged State: A temporary state. An escalation is always raised when transitioning to this state.
Log: Record of a condition that by design, does not trigger a state change
Event: Cause of state change, a function of logs and other events
Action: The set of one or more steps required to transition from one state to the next state.
Unacknowledged Event: An event without a prearranged action will trigger a transition to the unacknowledged state
Alert: A procedure where human action is required
Anomaly: Change to state which was not caused by a recognized event
Near miss: An anomaly where the system was nearing failure, but was averted with little margin to spare.

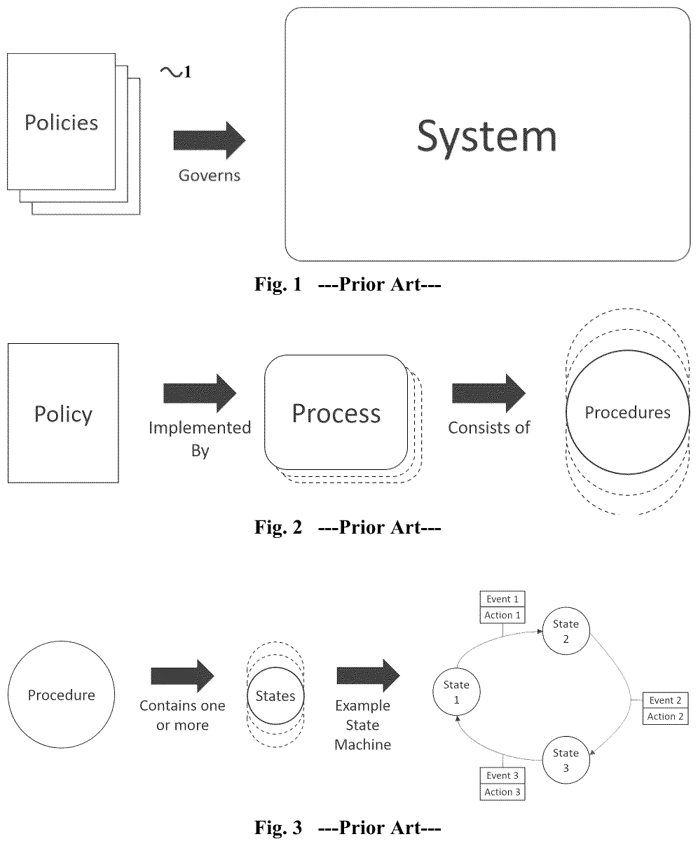

These next sections describe the standard system. As currently practiced and shown in FIG. 1, a set of policies 1 govern the behavior of a standard system. As currently practiced and shown in FIG. 2, each policy is implemented by a set of runbooks. Each runbook is composed of a set of processes. A process consists of one or more procedures. Each policy may be enabled or disabled.

As shown in FIG. 3, a procedure contains one or more states that represent steps of the procedure. An action is then executed to perform the transition from the current state to a new state. A state may have multiple events allowing transitions to several other states.

The next sections describe how the present invention is novel and modifies the standard system to enable highly reliable human interactions. The modified standard system is referred to as the “system” for the remainder of this document.

Management System—Implemented typically by the execution of digital code in a computing system. The software supports features needed to manage a standard system. Additionally, the software supports the present invention modification of the standard system and management of the resulting system. The Management System tracks changes made to the system. Operators of the system should use the Management System to make their changes to the system.

Each event will have a timestamp when it occurs. An action will have a timestamp when the transition initiates and a timestamp when it completes. Actions that cannot be completed successfully, or time out, will cancel the state transition and restore the current state. A system failure occurs when the system is not behaving as defined by governing policies.

An event may be triggered by a human or by other means. Events behave identically regardless of how they are triggered.

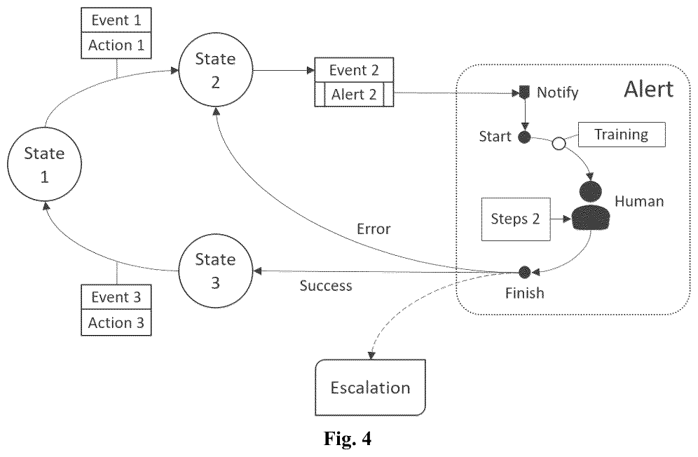

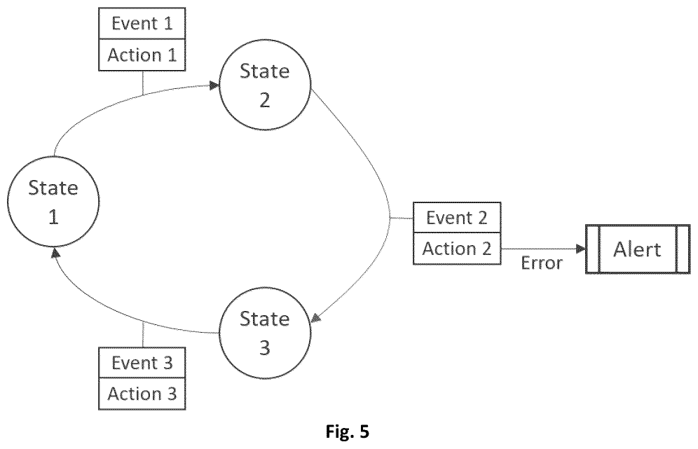

As shown in FIG. 4, any action that requires human interaction is handled by an alert. A notification is sent to inform a human an alert is pending. A human responds by starting the alert. In most cases, the human will then perform the steps listed in the alert. The related governance materials pertaining to the alert should be easily accessible for reference.

After successful completion of all steps, the alert finishes and the procedure transitions to the next state. A failure of any step will cause the procedure transition to stop and restore the current state. Examples of failure criteria include but are not limited to the time it takes to complete the step, measured or estimated numerical values of various parameters associated with the step, the capability and/or status of measurement equipment if used, the credentials, knowledge, health, and location of the person performing the step, etc. Many other criteria required for ensuring the successful completion of any given step can be identified by one skilled in the art. If there are any unexpected issues that cannot be resolved by the human, an escalation (defined in paragraph 37) is raised. During the escalation, the current procedure is halted until the escalation resolves the issue and provides direction on how to proceed.

If an alert has enabled a completion timer and the time expires by exceeding a predetermined maximum time value, the alert will terminate with an error and the procedure will restore the current state. Each alert may have different predetermined expiration time limits or acceptable ranges of time for step completion.

Training mode can be enabled to train or test humans on the current procedure. In testing mode, humans are periodically or randomly tested on various parameters including but not limited to their identity, health and knowledge of any part of the procedure, parent process, runbooks or overarching policy prior to performing any actions. Periodic testing helps ensure humans are fully capable of successfully completing the steps they are assigned to perform when operating the system.

The Management System may offer the human Recommendations (defined in paragraph 55) for improvements on handling the alert. The human has discretion to incorporate the Recommendations or handle the alert normally.

Relevant information about the human servicing the alert is saved. Any steps performed are logged. Timestamps for the notification, when the alert starts, when steps are started and completed, and when the alert finishes are saved.

Unexpected action condition—Actions are unattended by humans and performed automatically by the system, typically through the execution of digital code in a computing system. If an action encounters any unexpected conditions when performing the transition to the next state, the software executing the action may be configured to raise an alert.

The human processing the alert will attempt to resolve the issue to allow the procedure to continue. It is possible to conFig. the software executing the action to automatically restore the current state before raising the alert. This allows a human to investigate the error while not blocking the procedure. FIG. 5 shows a schematic representation of an unexpected action condition.

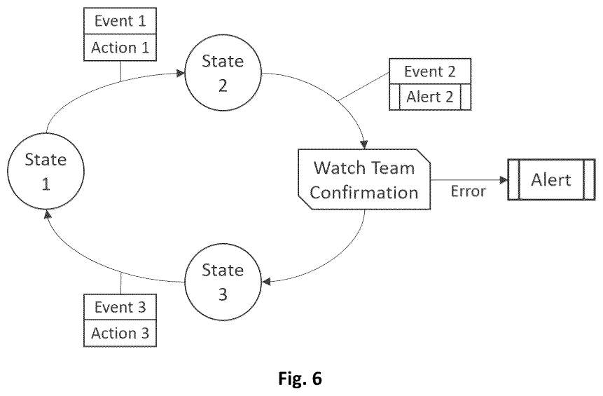

Watch Team Confirmation—as shown in FIG. 6, a Watch Team Confirmation is a special action defined within a procedure. The special action can be performed by one or more humans or by some other mechanism. When an action or alert is followed by a Watch Team Confirmation, the verification steps must be completed successfully before the transition to the next state can occur.

The verification steps should confirm that the associated action or alert has been completed properly. It is typical but not required that the procedure specifies the expected results of performing the action or alert, which can be referenced during verification. Examples of verification steps include but are not limited to confirming each step was completed on time, confirming the measured or estimated numerical values of various parameters associated with each step are within an acceptable range, confirming the capability and/or status of measurement equipment if used, confirming the credentials, knowledge, health, and location of the person performing each step, etc. Many other criteria required for confirming any given step can be identified by one skilled in the art.

If the Watch Team Confirmation detects any discrepancies, an alert is raised and the procedure remains halted until the alert can be cleared.

It is typical but not required that at least one Watch Team Confirmation is present for every procedure to confirm the final results. If desired, a Watch Team Confirmation may be used randomly or for every action/alert of the procedure.

Unacknowledged event—Events are explicitly defined within a procedure. It is expected each event will have a defined action or alert that will execute the necessary steps to transition to the next state. However, an event may arrive for a state where the event is not expected. These unacknowledged events do not have defined actions or alerts. This could happen if an unforeseen external change to the system occurred, generating the event, or there was an error with the procedure implementation.

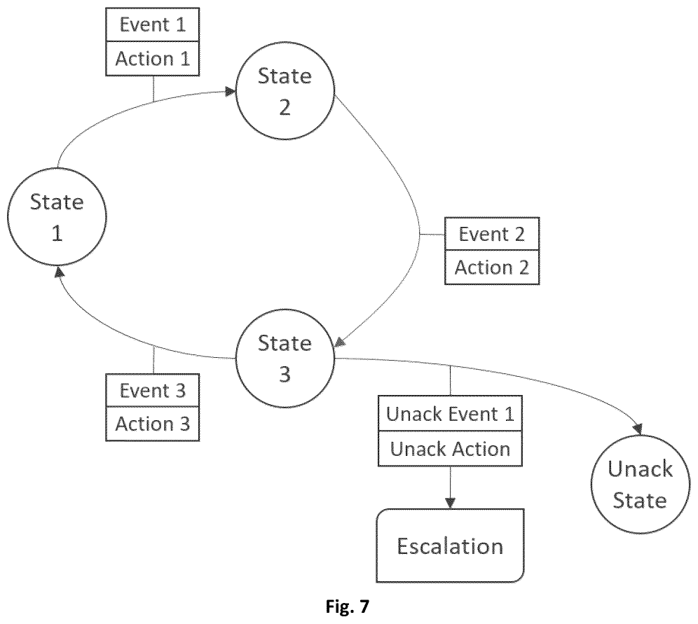

As shown in FIG. 7, the action for an unacknowledged event is always to trigger an escalation and transition to the unacknowledged state. This state will be present for every procedure. The escalation provides an opportunity to make corrections to the procedure, process, runbook, and/or policy and resume the procedure from the appropriate state.

Escalations—An escalation is raised whenever an issue cannot be resolved. They are typically serviced by more than one human. Relevant data triggering the escalation is maintained along with the occurrence timestamp and count of how often the underlying issue has been observed. Each step in the escalation is logged along with any related timestamps. The humans participating in the escalation should have relevant experience to best handle the issue.

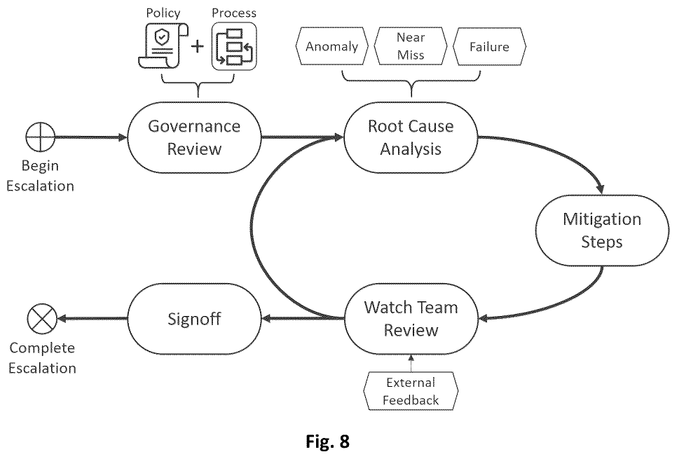

FIG. 8 shows a schematic representation of an escalation. The following is a description of each step:
Governance Review—step to examine the procedure, process, runbook and policy governing the underlying issue. Verify the procedures have been implemented correctly without any gaps in the process, runbook and/or policy definitions. Any governance related changes must maintain a version history along with information on why changes are being made. A count of escalations is maintained for each relevant policy, runbook, process and procedure.
Root Cause Analysis—step to determine the underlying cause of the issue. The issue category may be upgraded to an anomaly, near miss, or failure. Incorrect root cause analysis will likely result in the issue and escalation reoccurring.
Mitigation Steps—the recommended steps to mitigate the issue.
Watch Team Review—independent team to review findings and take into account any external feedback and Recommendations offered by the Management System. This team can recommend further root cause analysis to be conducted before the escalation can be completed.
Signoff—agreement from key stakeholders on the course of action to resolve the escalation. Any dissenters or governance deviations will require a supervisor to sign off.

Anomalies—an anomaly occurs when one or more procedures is in a state where it cannot be derived from a series of recorded events, actions, alerts and escalations. This can easily occur if the system was changed outside of the Management System responsible for tracking changes.

Detection of anomalies can be done directly by monitoring the state of the system and recognizing the system state is not the same as the expected state maintained in the Management System. Indirect detection of anomalies can occur when the system is not in a consistent state with the Management System when actions and alerts are being applied.

In most cases, the detection of the anomaly will initially start as an alert which will then initiate an escalation. The root cause analysis should then categorize the issue as an anomaly.

Sometimes an error in the governing policy, runbook and/or process did not properly define the expected system state causing the anomaly. Correcting the governance error should address the issue.

Near miss—a near miss is an anomaly that has reached the point of imminent system failure before it was mitigated. The steps to mitigate a near miss should be reflected back into the governing procedure, runbook, process and/or policy.

Feedback—feedback may be given about any part of the system or about the performance of any operator of the system. Feedback may be provided anonymously. The timestamp of when the feedback is entered is maintained. Feedback is expected to be reviewed in a timely manner. A timestamp on when the review starts and completes is maintained.

Any feedback that requires mitigation steps must have an alert generated.

Human Performance Score—the human performance score can be calculated for each work category within a system. A work category is a classification of human work experience needed to perform a specific task. As such, any one individual may have one or more performance scores, each one associated with a work category. An overall performance score, which is a weighted average of the work category performance scores, is maintained. More weight may be given to more recent work. The human performance scores can be used to provide an accurate breakdown of human performance across different categories of the system.

Calculating the human performance score—Updates occur when humans are doing work or when timeouts expire. The score is calculated over a period of time. Higher scores represent a higher level of human performance. Positive scores represent beneficial outcomes. Negative scores reflect detrimental outcomes.

Indicators that increase the human performance score:
Starting an alert before the time limit expires
Complete an alert step within the accepted time range.
Complete an alert before time limit expires
Correct answers to the periodic test questions
Successfully complete training
Successful Watch Team Confirmation result
Watch Team Confirmation discovers error ((+)Watch Team)
Feedback provided
Feedback reviewed before time limit expires
Escalation successfully resolves the issue. Points below increases score further:
   Experience level of humans are adequate
   Successful governance update
      Identify relevant governance before time limit expires
   Successful root cause analysis
      Completed before time limit expires
   Complete mitigation steps before time limit expires
   Watch Team Review approval
      Completed before time limit expires
   Unanimous sign off by all stakeholders
Other positive human performance indicators known by one skilled in the art

Indicators that decrease the human performance score:
Failure to start an alert before the time limit expires
Failure to complete an alert step before time limit expires
Failure to complete an alert before time limit expires
Incorrect answers to the periodic test questions
Failure to complete training
Watch Team Confirmation discovers error ((−)owner of error)
Failure to review feedback before time limit expires
Unacknowledged event occurred
Escalation occurred. Points below decreases score further:
   Experience level of humans not adequate
   Failure to identify governance
   Identify governance after time limit expires
   Unsuccessful root cause analysis
   Failed to complete root cause analysis before time limit expires
   Failed to complete mitigation steps before time limit expires
   Watch Team Review failures
      Completed after time limit expires
   Not unanimous sign off by stakeholders
   Repeated incidents decrease the score significantly
Escalation failed to mitigate issue
Anomaly occurred
Near miss occurred
System failure occurred
Other negative human performance score indicators known by one skilled in the art

Human Performance Score Relative Weightings—the following are example relative weightings that affect how the human performance score can be calculated. In one embodiment of the invention, the increasing magnitude of effect to the human performance score is listed as follows. Other embodiments of the invention may change the weighting order or weighting categories.
Anonymous feedback will have the smallest effect on human performance. Non-anonymous feedback will have a slightly larger effect. Feedback that results in governance changes will have a much larger effect.
Time limit completion affects the score more than feedback. Completion further from the limit will have a slightly larger effect.
Alerts will affect the score more than time limits. Alerts with more steps will have a larger effect.
Testing will affect the score more than alerts.
Watch Team Confirmations will affect the score more than testing.
Training will affect the score more than Watch Team Confirmations.
Unacknowledged events will affect the score more than training.
Escalations affect the score more than unacknowledged events.
Anomalies affect the score more than escalations.
Near misses affect the score more than anomalies.
System failures have the largest effect on the score.

Human Performance Score Modifiers—under normal conditions, a human is expected to perform tasks at or near their given human performance score. Other factors affecting the human may have a positive or negative effect on the human performance. These factors include:
Experience. A human with experience with a given task may perform at a higher level, increasing their human performance score. Similarly, a human with little experience with a given task may perform at a lower level, decreasing their human performance score.
Health. A human not in good health may perform at a lower level, decreasing their human performance score.
Workload. A human under a heavy workload may perform at a lower level, decreasing their human performance score.
Teamwork. A human with strong teamwork skills may perform at a higher level in a group setting, increasing their human performance score. Similarly, a human with weak teamwork skills may perform at a lower level in a group setting, decreasing their human performance score.
Location. A human may need to be physically at a specific location to effectively perform the task. A human not at the location may perform at a lower level, decreasing their human performance score.
Language. A human not fluent in the native language may perform at a lower level, decreasing their human performance score.
Other factors may also cause the human to perform at a different level, affecting their human performance score.
   Whenever any of these factors affects a human, the effective human performance score needs to be adjusted while the condition persists.

Hierarchy—An overall human performance score is calculated for each individual human. A team's human performance score is a weighted average of the human performance scores of all team members. An organization's human performance score is a weighted average of each team's human performance score within an organization.

Process Efficiency—a process that does not experience any errors, unacknowledged events, or escalations over a period of time is 100% efficient. In one embodiment of the invention, errors reduce the process efficiency by a small amount, unacknowledged events reduce by a moderate amount and escalations reduce by a large amount.

If the policy or runbook governing the process is not active, the process efficiency is 0% during the time the policy is inactive.

Recommendations—The Management System may offer recommendations about improving policies, runbooks, processes, procedures, alerts, escalations, human performance and other topics. The recommendations may be based on data from the current organization, from other organizations, from artificial intelligence/machine learning analysis and/or from other sources.

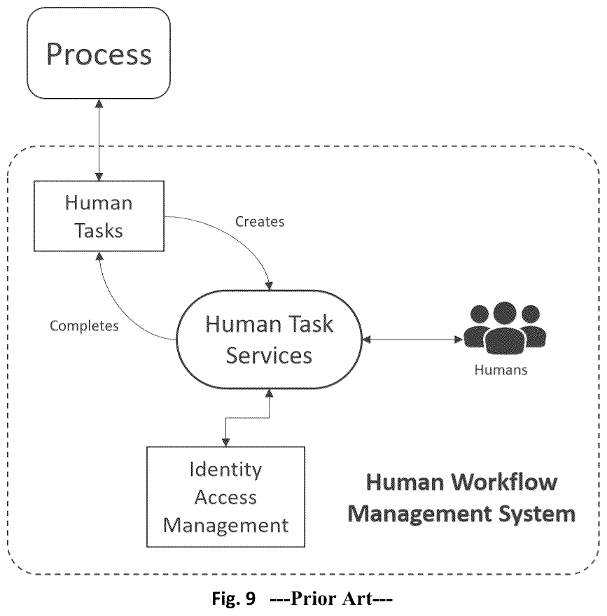

Human Workflow Management System Definition—as shown in FIG. 9, a human workflow management system, as currently practiced, is used for tracking and managing human tasks. In one embodiment of the present invention, the Human Workflow Management System is one part of the overall Management System, but in other embodiments of the present invention, the Human Workflow Management System may operate independently. Processes that require human interaction can be structured to include human tasks that are created by a human workflow management system. Typically, such systems are the execution of digital code in a computing system, but may be some other mechanism. The software will manage the method of selecting a human or humans to work on tasks and oversee each task is completed in a timely manner. The software verifies every human is authorized to work on the task. When tasks are completed, the process requesting the task is notified.

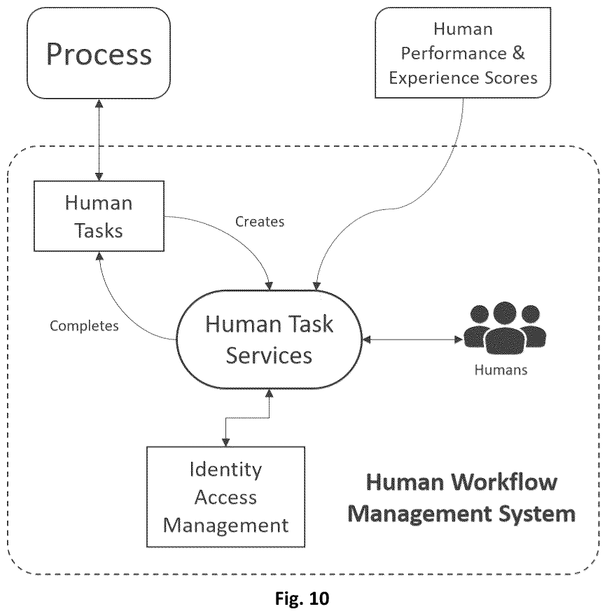

Using Human Performance Scores—FIG. 10, shows how the present invention is novel and enhances the human workflow management systems. Enhanced human workflow management systems can take advantage of human performance scores to optimize how humans are allocated to tasks within a system.

Defining Levels—ranges of human performance scores can be used to define levels. These levels can then be applied in other areas of the human workflow management system.

Leaderboards, Charts, and Tables—individual human and team leaderboards can be used to gauge overall human performance of the organization. Charts, tables and other graphics can show trends, statistics and any other indicators of human performance. This data can be used to help improve the organization's human performance scores and ability to execute various processes reliably.

Incentives and Achievements—various incentives and achievements can be provided to humans and teams on reaching and maintaining human performance milestones.

Determining Qualified Humans for a Task—the human performance score can be used to filter out unqualified humans from performing complex tasks. A task may specify a minimum human performance score to be eligible to work on the task. Highly specialized work may require a high human performance score for one or more categories before a human is allowed to perform the task.

More generalized work may only require a low human performance score for a single category or may not have a human performance score requirement in any work categories, but instead specify a minimum overall human performance score to be eligible for the task.

Triggering Specialized Human Workflows—changes to human performance scores may trigger specialized human workflows. These workflows can be used to execute human procedures that may be difficult to fully define within a process. For example, failing to complete an alert on time may trigger a workflow task for a supervisor to reassign the task. These types of human behaviors may be better suited for a human workflow management system rather than attempting to enumerate the human behavior within a process.

Real-time Responses to Human Performance Scores—a human workflow management system can react in real-time to changes in human performance scores.

Positive Changes May have the Following (or Other) Effects:
The user interface may provide some form of positive recognition to the human.
Human performance successes can trigger specialized human workflows.
Supervisor may be notified.
The team may be informed.
Leaderboards will reflect positional changes.
Score and level milestones may be announced.
Achievements reached may be announced.
Level increases.
Data visualization updates.
   Negative Changes May have the Following (or Other) Effects:
The user interface may provide some form of negative feedback to the human.
Human performance failures can trigger specialized human workflows.
The human may no longer be qualified to perform the task.
Supervisor may be notified.
The team may be notified.
Leaderboards will reflect positional changes.
Level decreases.
Data visualization updates.

Application of Present Invention—the invention is generic and it can be applied to a wide range of applications. The following are examples of applications that benefit from the invention:
Enterprise Cybersecurity. Human error is at the heart of many cybersecurity breaches. Improving the human performance of cybersecurity operations will improve the organization's cybersecurity posture.
Cyber Insurance Underwriting. The cost of cyber breaches has been growing exponentially. Providers of cyber insurance do not have reliable methods of quantifying risk and they are forced to raise premiums or exit the market entirely. Having the ability to observe an organization's human performance and how it affects cybersecurity effectiveness will enable insurance providers to accurately calibrate their risk models and appropriately price premiums.
Software Development and Distribution. Cyber criminals are actively seeking to infiltrate the software development and distribution processes in order to have a software publisher unknowingly distribute malware along with their production builds. Addressing human performance at these high value targets should reduce the threat of these types of attacks.
Other Applications. Anyone skilled in the art can apply the invention to different applications.

What is claimed is:

1. A method to ensure the reliable operation of a process, said method comprised of structuring the process as a sequence of states wherein the transition between states is conditional on one or more events, and at least one transition also requires one or more humans to complete one or more steps, wherein the completion of said one or more steps also includes generating a human performance score for at least one of the humans completing at least one of the steps.

2. The method in claim 1, wherein said events include every event known to affect one or more state transitions between a beginning state and an end state, and wherein said steps to be performed by humans include every step required to advance from a beginning state to an end state.

3. The method in claim 1, wherein at least one of the steps completed by one or more humans is a Watch Team Confirmation decision on whether or not to require one or more additional events or steps.

4. The method in claim 1, wherein at least one of the steps completed by one or more humans is an escalation decision on whether or not to require at least one or more additional events or one or more additional steps that must be performed by one or more additional humans.

5. The method in claim 1, wherein said process evaluation allows the recording of at least one or more anomalies, near misses and feedback.

6. The method in claim 1, wherein a recommendation is made to improve one or more of the policies, runbooks, processes, procedures, alerts, escalations and/or human performance scores.

7. A method to compute human performance scores comprised of:
means for computing an individual human performance score from one or more collected individual human performance indicators;
means for computing an aggregate team human performance score from a plurality of individual human performance scores;
means for computing an aggregate organization human performance score from a plurality of team human performance scores.

8. The method in claim 7, wherein said human performance indicators include, but are not limited to, one or more of:
elapsed time to start an alert;
elapsed time to complete an alert;
elapsed time to review feedback;
feedback content provided;
training successfully completed on time;
successful Watch Team confirmation result;
count of escalations that resolve successfully;
count of escalations raised;
count of governance updates from raised escalations;
count of root cause analysis from raised escalations;
elapsed time to complete mitigation steps from raised escalations;
successful Watch Team approvals from raised escalations.

9. The method in claim 7, wherein the accuracy of the human performance score is improved by including one or more of:
the effect of experience of the human operator;
the effect of health of the human operator;
the effect of the workload of the human operator;
the effect of the teamwork ability of the human operator;
the effect of the location of the human operator:
the effect of the language of the human operator;

10. The method in claim 7, wherein the time worked by each individual is collected and the aggregate time worked for teams or organizations or both is also collected or derived from the time worked by one or more individuals who are members of the same team or organization.

11. The method in claim 7, wherein said performance indicators are labelled with the corresponding time when collected into a set that is then stored to a database which can be queried by time, individual, team, organization or by indicator type and value.

12. The method in claim 7, wherein said performance scores are labelled with the corresponding time when computed into a set that is then stored to a database which can be queried by time, individual, team, organization and value.

13. A method to improve the ability of an organization to complete various steps in a process, said method including the collection, storage, analysis and visualization of the human performance indicators and scores of one or more humans completing the steps, wherein said collection can be from historical performance, real-time performance, or both.

14. The method in claim 13, wherein said human performance indicators include individual, team and organization performance scores and performance indicators are used by a human workflow management system.

15. The method in claim 13, wherein said performance scores are assigned to a set of levels based on the value of the score.

16. The method in claim 13, wherein said human, team and organization performance scores are organized and visualized as a leaderboard.

17. The method in claim 13, wherein said performance scores are used as a source of incentives for the individuals, teams and organizations.

18. The method in claim 13, wherein said human performance scores are used to determine whether an individual is qualified to operate a process.

19. The method in claim 13, wherein said human performance scores are used to trigger specialized human workflows.

20. The method in claim 13, wherein one or more of said human, team, and/or organization performance scores are used in commerce to assess the risk of a human, team, and/or organization's ability to perform, wherein the cost of services to be rendered by and/or insurance against failure to perform by the human, team, and/or organization is calculated based on said assessed risk.
